(19) United States
(12) Patent Application Publication
(10) Pub. No.: US 2006/0088059 A1
(43) Pub. Date: Apr. 27, 2006

(54) Apparatus and method for processing data in a communication system

(75) Inventors: Jae-In Lim, Suwon-si (KR); Dong-Soo Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/259,048

(22) Filed: Oct. 27, 2005

(30) Foreign Application Priority Data
Oct. 27, 2004 (KR) 2004-86307

(51) Int. Cl. H04J 3/16

(52) U.S. Cl. 370/469

(57) ABSTRACT

A data processing apparatus connected to a core network in a communication system and a data processing method therefor are provided. In the data processing apparatus, at least one slow packet processing shelf performs a lower layer operation on traffic received through the low-rate data line. At least one fast packet processing shelf performs a lower layer operation on traffic received through the high-rate data line. If the traffic processed in the packet processing shelves needs high-performance data processing, the traffic is transmitted to at least one data processing shelf. The data processing shelf performs an upper layer operation on the traffics received from the packet processing shelves. A cell switch switches between the packet processing shelves and the data processing shelf.

### PRIORITY

This application claims the benefit under 35 U.S.C. § 119(a) of a Korean Patent Application entitled “Apparatus and Method for Processing Data in a Communication System”, filed in the Korean Intellectual Property Office on Oct. 27, 2004 and assigned Serial No. 2004-86307, the entire contents of which are hereby incorporated by reference.

### BACKGROUND OF THE INVENTION

1. Field of the Invention

The present invention relates generally to a communication system. In particular, the present invention relates to a data processing apparatus and method for use in a core network (CN) and an access network connected to the CN.

2. Description of the Related Art

Data processing apparatuses connected to a CN and an access network comprises a base station controller (BSC), a server, and a media gateway. Along with the trend toward high integration and high performance driven by today's technology development, access devices need to process more data relative to conventional ones. Thus, a need exists for expanding conventional data processing apparatuses to process more data.

FIG. 1 is a block diagram illustrating an expanded configuration of a conventional data processing apparatus in one shelf.

Referring to FIG. 1, the data processing apparatus comprises a switch 110, data/line processors 120 through 130, and input/output portions 150 through 160. The input/output portions 150 through 160 take charge of cabling related to network connection and network management. The data/line processors 120 through 130 each comprise a data processor and a line processor. They interwork with an external network and transmit packets. That is, the data/line processors 120 through 130 transmit received traffic to an appropriate board according to the characteristics of the traffic, controlling the quality of service (QoS) of the traffic through packet classification, policing, queuing, and scheduling. They also perform a signaling protocol needed to control the QoS of the traffic. The switch 110 switches data traffic processed by the data/line processors 120 through 130 according to an output path.

This data processing apparatus can be expanded as follows. First, the data/line processors are expanded within the shelf. Since the expansion must be done within the capacity of the switch, there are limitations in processing a large volume of data. To solve this problem, the shelf is expanded by use of a large capacity switch, as illustrated in FIG. 2.

FIG. 2 is a block diagram illustrating an expanded configuration of another conventional data processing apparatus using a plurality of shelves.

Referring to FIG. 2, the data processing apparatus comprises a plurality of shelves 220 through 230 and a large capacity switch 210 for switching data traffic processed by the shelves 220 through 230 to appropriate paths. The shelves 220 through 230 are similar or identical to that illustrated in FIG. 1. Therefore, input/output portions 227 through 229 (or 237 through 239) serve as a physical interface for receiving/transmitting data traffic from/to an external system, and data/line processors 223 through 225 (or 233 through 235) process data traffic received from the input/output portions 227 through 229 (or 237 through 239) in each of the shelves 220 through 230. The data/line processors 223 through 225 (or 233 through 235) cover from lower layer operations such as received packet processing to upper layer operations comprising bearer platform functionality for processing a large capacity complex protocol and data and control-plane functionality for processing bearer platform signals, controlling, and managing resources. Each switch 221 or 231 in each shelf 220 (or 230) switches data received from the data/line processors 223 through 225 (or 233 through 235) to a predetermined data processor. The large capacity switch 210 connects the switches 221 through 231 and switches transmission packets to a predetermined shelf.

The above data processing apparatus is configured by expanding a small capacity switch to a large capacity switch. That is, a plurality of shelves each having data/line processors are added to expand the data processing apparatus. In the data processing apparatus, when a data processor needs to be expanded, a line processor is also unnecessarily expanded. That is, in the case where only a data processor is expanded, each board within a shelf requires an expensive switch interface configuration even though there is no limitation on input/output interface capacity.

### SUMMARY OF THE INVENTION

An object of the present invention is to solve at least the above problems and/or disadvantages and to provide at least the advantages below. Accordingly, an object of the present invention is to provide a data processing apparatus and method for enabling separate expansion of a line processor and a data processor.

Another object of the present invention is to provide a data processing apparatus which can be efficiently expanded with less cost and a data processing method therefor.

The above objects can be achieved by providing a data processing apparatus and method for a core network and an access network connected to the core network in a communication system.

According to one aspect of the present invention, a data processing apparatus is provided for a core network and an access network connected to the core network in a communication system. The apparatus comprises at least one slow packet processing shelf, connected to a low-rate data line, performs a lower layer operation on traffic received through the low-rate data line, and if the traffic needs high-performance data processing, transmits the traffic to a shelf for performing an upper layer operation. The apparatus further comprises at least one fast packet processing shelf, connected to a high-rate data line, performs a lower layer operation on traffic received through the high-rate data line, and if the traffic needs high-performance data processing, transmits the traffic to the shelf for performing the upper layer operation. At least one data processing shelf performs the upper layer operation on the traffics received from the packet processing shelves. A cell switch switches between the packet processing shelves and the data processing shelf.

The slow packet processing shelf comprises at least one slow packet processor for receiving low-rate data traffic through the low-rate data line and performing an input and output operation, a data link layer operation, and a network layer operation on the low-rate data traffic, and a switch interface for, if the data traffic needs the upper layer operation, switching the low-rate data traffic to the data processing shelf and managing and controlling the slow packet processing shelf.

The switch interface of the slow packet processing shelf comprises a network processor unit (NPU) for allocating an address to the low-rate data traffic received from the slow packet processor, in order to establish a traffic path in which the low-rate data traffic is transmitted from the slow packet processor to the data processing shelf, and an Ethernet switch for switching data traffic between the slow packet processor and the data processing shelf.

The fast packet processing shelf comprises at least one fast packet processor for receiving high-rate data traffic through the high-rate data line and performing an input and output operation, a data link layer operation, and a network layer operation on the high-rate data traffic, and a switch interface for, if the data traffic needs the upper layer operation, switching the high-rate data traffic to the data processing shelf and managing and controlling the fast packet processing shelf.

The switch interface of the fast packet processing shelf comprises a NPU for allocating an address to the high-rate data traffic received from the fast packet processor, in order to establish a traffic path in which the high-rate data traffic is transmitted from the fast packet processor to the data processing shelf, and an Ethernet switch for switching data traffic between the fast packet processor and the data processing shelf.

The data processing shelf comprises at least one data processor for performing the upper layer operation on data traffic received from the packet processing shelves, and a switch interface for switching between the data processor and the packet processing shelves, and managing and controlling the data processing shelf.

The switch interface of the data processing shelf comprises a NPU for allocating addresses to the data traffic received from the packet processing shelves and the data traffic processed in the data processor, in order to establish traffic paths for the data traffics, and an Ethernet switch for switching the data traffic between the packet processing shelves and the data processor.

According to another aspect of the present invention, a data processing method is provided in a data processing apparatus having a packet processing shelf for receiving data traffics separately through a high-rate data line and a low-rate data line and performing a lower layer operation on the data traffics, and a data processing shelf for performing an upper layer operation on the data traffics in a communication system. When a data traffic is received, a lower layer operation is performed on the data traffic, and it is determined whether the data traffic needs high-performance data processing or an upper layer operation in the packet processing shelf. The data traffic is switched to the data processing shelf, if the data traffic needs the upper layer operation. The upper layer operation is performed on the data traffic, and the processed data traffic is switched for transmission in the data processing shelf.

In the switching step, an address is allocated to the data traffic processed in the packet processing shelf to establish a path to the data processing shelf, and the data traffic is switched to the data processing shelf according to the address.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an expanded configuration of a conventional data processing apparatus in one shelf;

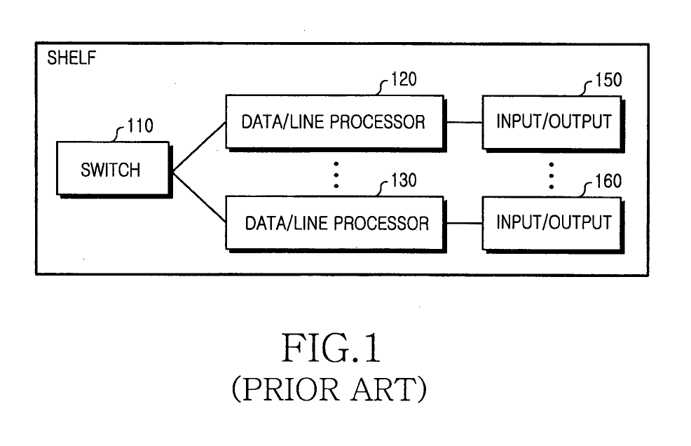

FIG. 2 is a block diagram illustrating another expanded configuration of a conventional data processing apparatus using a plurality of shelves;

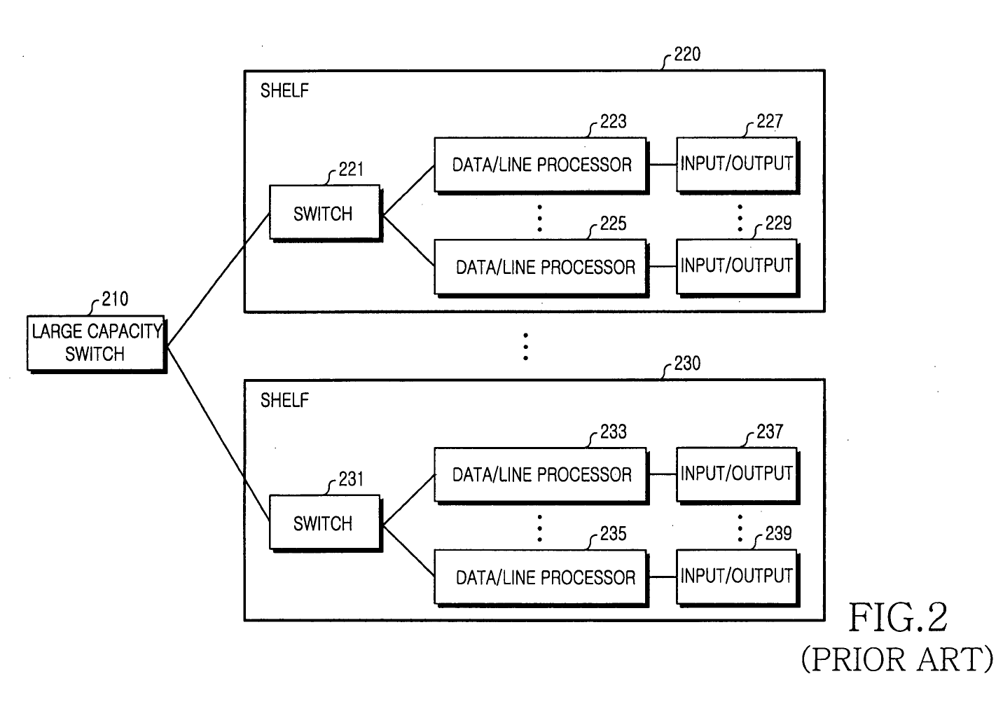

FIG. 3 is a block diagram illustrating an expanded data processing apparatus according to an exemplary embodiment of the present invention; and

FIG. 4 is a flowchart illustrating an operation for processing data traffic in the data processing apparatus according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will be described herein below with reference to the accompanying drawings. In the following description, well-known functions or constructions will be omitted for clarity and conciseness.

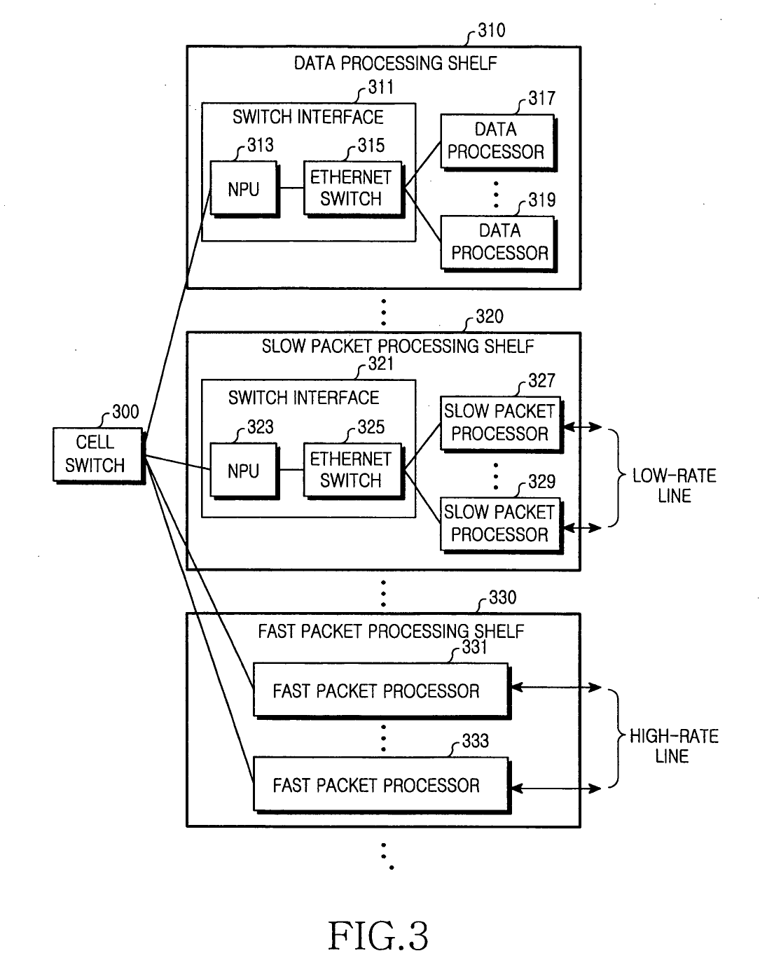

FIG. 3 is a block diagram illustrating an expanded data processing apparatus according to an exemplary embodiment of the present invention. According to an exemplary implementation in a data processing apparatus, upper layer processing and lower layer processing can be separated in processing data traffic in a plurality of shelves.

Referring to FIG. 3, the data processing apparatus is divided by function into a data processing shelf 310, a slow packet processing shelf 320, and a fast packet processing shelf 330. Thus data traffic received from an external system can be subject to packet processing and signaling protocol processing, separately. For each function, at least one shelf is provided. A cell switch 300 is a large capacity switch connected to the shelves and a high-performance packet processing card, for switching data traffics to traffic paths.

The data processing shelf 310 comprises a switch interface 311 and a plurality of data processors 317 through 319.

Each of the data processors 317 through 319 has a high-performance central processing unit (CPU). Thus, the data processor processes data traffic received from another shelf with respect to a signaling protocol and in addition, in L2 when needed. That is, the data processor is used to process a complex protocol and a large volume of data and to perform a control function for processing system signals, controlling, and managing resources. For example, in ia BSC, the data processor allocates resources required for call processing. It manages the load of an air termination processor for processing radio link protocol (RLP) to medium access control (MAC) protocols and allocates resources to a new service according to the load information. Also, it provides an appropriate structure for call processing, handoff, and session management. The data processor adds an Ethernet address to data traffic to indicate a path to which an Ethernet switch 315 switches in the switch interface 311.

The switch interface 311 is connected between the data processors 317 through 319 and the cell switch 300. The switch interface 311 allocates an Ethernet address to indicate where data traffic received from another shelf is to be processed in a data processor, performs Ethernet switching, and allocates a large capacity switch address to data traffic in order to indicate a path to which the cell switch 300 switches.

This switch interface 311 comprises the Ethernet switch 315 and a network processor unit (NPU) 313. The Ethernet switch 315 switches data traffic received from the cell switch 300 selectively to the data processors 317 through 319.

The NPU 313 adds an address to data traffic received from the Ethernet switch 315 to indicate a traffic path running to the cell switch 300. The NPU 313 can process packets at or above 2 Gbps. The NPU 313 is responsible for receiver processing such as parsing and storing, transmitter processing such as packet classification, quality of service (QoS) control, assembling, and transmission, and statistics. The NPU functionalities are summarized as follows.

The NPU 313 supports (1) a lookup function for L3 forwarding, (2) a lookup function for each flow for classification, (3) QoS-related functions comprising metering, marking, shaping and policing, (4) flow control and algorithms comprising RED and WRED for avoiding traffic congestion, and (5) statistics processing such as user session, interface, internet protocol (IP), packet size range, IP sec, and DiffServ Class.

The switch interface 311 controls the path of data traffic received from the cell switch 300 and adds an address for controlling the traffic path of the cell switch 300 to the data traffic in order to output the data traffic. The switch interface 311 also provides operation, administration, management, and provision (OAM&P) over the system within the shelf.

The OAM&P functionality manages the overall data processing shelf, hosts the processor boards within the shelf, and enables exchange of control information between whole OAM&P boards in the system. An OAM&P function block initializes itself and the NPU 313 based on received booting information. The OAM&P function block receives packets that cannot be processed by the NPU 313 and processes routing protocol-related packets.

The slow packet processing shelf 320 comprises a switch interface 321 and a plurality of slow packet processors 327 through 329.

The switch interface 321 is connected between the cell switch 300 and the slow packet processors 327 through 329, for providing a data traffic path.

Each of the slow packet processors 327 through 329 has an input/output portion connected a low-rate line such as T1 or E1 and thus processes only low-rate data traffic received from an external device. The slow packet processors 327 through 329 basically perform a L1 operation related to input/output and a L2 and L3 operation such as Ethernet and IP routing. When the payload of received data traffic needs to be processed additionally, that is, when a bearer platform function or a control-plane function is to be performed, the slow packet processors 327 through 329 transmit the low-rate data traffic to the switch interface 321 so that the low-rate data traffic can be provided to the data processors 317 through 319. The switch interface 321 is configured to comprise a NPU 323 and an Ethernet switch 325. The switch interface 321 operates in the same manner as the switch interface 311 in the data processing shelf 310.

The fast packet processing shelf 330 comprises a plurality of fast packet processors 331 through 333. While not shown, each of the fast packet processors 331 through 333 comprises a switch interface as in the slow packet processing shelf 320. The fast packet processors 331 through 333 each have an input/output portion connected to a fast external line of a mega level such as fast Ethernet (100 Mbps) and STM-1 (155 Mbps) or of a giga level such as gigabit Ethernet. That is, the fast packet processors 331 through 333 receive or transmit high-rate packet data through the input/output portions and perform a lower layer operation such as packet processing.

Basically, the fast packet processors 331 through 333 perform L2 and L3 operations comprising Ethernet or IP routing on received data traffic or transmission data traffic. However, they require high-performance processors when an additional operation like signaling protocol processing is needed. Therefore, they transmit data traffic to the data processors 317 through 319 through the cell switch 300.

Each of the above-described shelves switches data traffic to a predetermined address through the cell switch 300. Consequently, the cell switch 300 switches data traffic received from the slow packet processing shelf 320 or the fast packet processing shelf 330 to a transmission path or switches data traffic processed by the data processing shelf 310 to an external path.

According to an exemplary embodiment of the present invention, the data processing apparatus is so configured that a shelf for processing packets is separated from a shelf for performing an upper layer operation such as signaling protocol processing required for QoS control of received traffic or processing data with high performance. Therefore, the data processing apparatus can be expanded by function within the capacity of the cell switch.

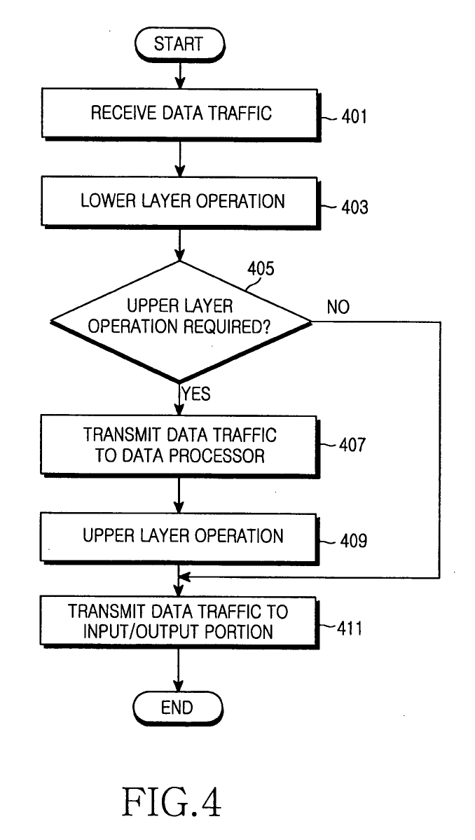

FIG. 4 is a flowchart illustrating an operation for processing data traffic in the data processing apparatus according to an exemplary embodiment of the present invention. With reference to FIG. 4, a data traffic process in the data processing apparatus illustrated in FIG. 3 will be described. For convenience sake, it is assumed that data traffic is high-rate data and received at a fast packet processor. Referring to FIG. 4, a fast packet processor having an input/output portion receives data traffic in step 401 and performs L2 and L3 operations such as Ethernet and IP routing on the received data traffic in step 403. In step 405, the fast packet processor determines whether a high-performance data process is required for the data traffic, such as signaling protocol processing for QoS control. If the high-performance process is not needed, the fast packet processor outputs the data traffic to a predetermined output portion in step 411. If the data traffic needs the high-performance data process, that is, an upper layer process is needed, the fast packet processor provides the data traffic to a predetermined data processor through the cell switch in step 407. The data processor performs an upper layer operation on the data traffic in step 409 and transmits the processed data traffic to the input/output portion of a predetermined fast or slow packet processor through the cell switch 300 in step 411. In an exemplary embodiment of the present invention, while the data processor takes charge of upper layer operations, it can perform a L2 operation when needed.

In accordance with the present invention as described above, a line processor for processing in a physical layer and a network layer is separately implemented from a data processor for processing with high performance in the data processing apparatus. Therefore, a large volume of data can be processed and the data processor can be expanded without unnecessarily adding input/output portions.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A data processing apparatus for a core network and an access network connected to the core network in a communication system, the data processing apparatus comprising:
at least one slow packet processing shelf connected to a low-rate data line, for performing a lower layer operation on traffic received through the low-rate data line;
at least one fast packet processing shelf connected to a high-rate data line, for performing a lower layer operation on traffic received through the high-rate data line;
at least one data processing shelf for performing an upper layer operation on the traffics received from the packet processing shelves; and
a cell switch for switching between the packet processing shelves and the data processing shelf.

2. The data processing apparatus of claim 1, wherein the low-rate data line comprises at least one of T1 and E1 lines.

3. The data processing apparatus of claim 2, wherein the at least one slow packet processing shelf comprises:
at least one slow packet processor for receiving low-rate data traffic through the low-rate data line and performing an input and output operation, a data link layer operation, and a network layer operation on the low-rate data traffic; and
a switch interface for, if the data traffic requires an upper layer operation, switching the low-rate data traffic to the data processing shelf and managing and controlling the slow packet processing shelf.

4. The data processing apparatus of claim 3, wherein the switch interface comprises:
a network processor unit (NPU) for allocating an address to the low-rate data traffic received from the slow packet processor, in order to establish a traffic path in which the low-rate data traffic is transmitted from the slow packet processor to the data processing shelf; and
an Ethernet switch for switching data traffic between the slow packet processor and the data processing shelf.

5. The data processing apparatus of claim 1, wherein the high-rate data line comprises at least one of a mega level line of fast Ethernet and STM-1 and a giga level line of gigabit Ethernet.

6. The data processing apparatus of claim 1, wherein the at least one fast packet processing shelf comprises:
at least one fast packet processor for receiving high-rate data traffic through the high-rate data line and performing an input and output operation, a data link layer operation, and a network layer operation on the high-rate data traffic; and
a switch interface for, if the data traffic requires an upper layer operation, switching the high-rate data traffic to the data processing shelf and managing and controlling the fast packet processing shelf.

7. The data processing apparatus of claim 6, wherein the switch interface comprises:
a network processor unit (NPU) for allocating an address to the high-rate data traffic received from the fast packet processor, in order to establish a traffic path in which the high-rate data traffic is transmitted from the fast packet processor to the data processing shelf; and
an Ethernet switch for switching data traffic between the fast packet processor and the data processing shelf.

8. The data processing apparatus of claim 1, wherein the at least one data processing shelf comprises:
at least one data processor for performing the upper layer operation on data traffic received from the packet processing shelves; and
a switch interface for switching between the data processor and the packet processing shelves, and managing and controlling the data processing shelf.

9. The data processing apparatus of claim 8, wherein the switch interface comprises:
a network processor unit (NPU) for allocating addresses to the data traffic received from the packet processing shelves and the data traffic processed in the data processor, in order to establish traffic paths for the data traffics; and
an Ethernet switch for switching the data traffic between the packet processing shelves and the data processor.

10. The data processing apparatus of claim 1, wherein if the traffic needs high-performance data processing, the traffic is transmitted to a shelf for performing an upper layer operation.

11. A data processing method for a data processing apparatus comprising a packet processing shelf for receiving data traffics separately through a high-rate data line and a low-rate data line and performing a lower layer operation on the data traffics, and a data processing shelf for performing an upper layer operation on the data traffics in a communication system, the data processing method comprises the steps of:
receiving a data traffic, performing a lower layer operation on the data traffic, and determining whether the data traffic requires high-performance data processing or an upper layer operation in the packet processing shelf;
switching the data traffic to the data processing shelf, if the data traffic requires the upper layer operation; and
receiving the data traffic, performing the upper layer operation on the data traffic, and switching the processed data traffic for transmission in the data processing shelf.

12. The data processing method of claim 10, wherein the switching step comprises the steps of:
allocating an address to the data traffic processed in the packet processing shelf to establish a path to the data processing shelf; and
switching the data traffic to the data processing shelf according to the address.

13. The data processing method of claim 10, wherein the high-rate data line comprises at least one of a mega level line of fast Ethernet and STM-1 and a giga level line of gigabit Ethernet.

14. The data processing method of claim 10, wherein the low-rate data line comprises at least one of T1 and E1 lines.
